(19) United States
(12) Patent Application Publication
(10) Pub. No.: US 2026/0213296 A1
(43) Pub. Date: Jul. 23, 2026

(54) Thermal Management System for Battery With Automatic Hot Spot Detection to Deliver Variable Cooling Rate

(71) Applicant: Mercedes-Benz Group AG, Stuttgart (DE)

(72) Inventors: Siva SYLESH, Bengaluru (IN); Atul GUPTA, Bangalore (IN); Sachin SINGHAL, Bangalore (IN); Neethu MOHAN, Bengaluru (IN)

(21) Appl. No.: 19/140,862

(22) PCT Filed: Dec. 7, 2023
(86) PCT No.: PCT/EP2023/025513

§ 371 Date: Jun. 18, 2025

(30) Foreign Application Priority Data
Dec. 20, 2022 (IN) 202211073997

(51) Int. Cl. H01M 10/653; B60L 50/64; H01M 10/613; H01M 10/615; H01M 10/625; H01M 10/6554; H01M 10/6567; H01M 10/6571; H01M 50/249

(52) U.S. Cl. CPC H01M 10/653; H01M 10/613; H01M 10/615; H01M 10/625; H01M 10/6554; H01M 10/6567; H01M 10/6571; H01M 50/249; B60L 50/64; H01M 2220/20

(57) ABSTRACT

A thermal management system of a battery module includes a thermally conductive plate where one or more cells associated with the battery module are in thermal contact with a first side of the thermally conductive plate and where a coolant with ferromagnetic materials is configured to flow in thermal contact with a second side of the thermally conductive plate. One or more coils configured at predefined positions in the battery module are on the first side of the thermally conductive plate where, in an event of heating of the one or more cells, the one or more coils are configured to get electromagnetically induced upon actuation by a DC current. One or more electromagnetically-induced coils on the first side of the thermally conductive plate are adapted to attract the ferromagnetic materials of the coolant toward the second side of the thermally conductive plate.

### BACKGROUND AND SUMMARY OF THE INVENTION

The present disclosure relates generally to the field of thermal management in batteries. In particular, the present disclosure pertains to a simple, compact, efficient, and active thermal management system for a battery, which provides improved heat transfer capability and automatic hot spot detection to deliver efficient and variable cooling rates.

Batteries are generally employed in equipment and vehicles as an energy storage device that provides electrical power to electronic and electrical components associated with the vehicle and equipment. Batteries such as high voltage (HV) batteries also act as the main propulsion source in electric and hybrid vehicles. Vehicles may include a battery pack including one or more arrays of battery modules where each battery module may include one or more cells interconnected electrically between battery cell terminals and interconnector busbars.

Vehicles generally include a battery management system to control the charging operation of the battery. In electric and hybrid vehicles, contemporary research has been focused on improving the battery charging times in order to give customers a fast charging experience akin to refueling times. This is typically achieved by very high charging currents/voltages. The increased power transfer puts thermal stress on the battery which has undesirable effects such as reduced battery life, poor charging performance, and thermal runaway in extreme cases.

Batteries have the best charging performance in a narrow temperature range typically between 20° C.-45° C. However, during fast charging with high power, the heating of the battery happens at a high rate and hence it needs active thermal management of the battery. Moreover, due to the indifferent degradation of cells within the battery over time, hot spots can form wherein one cell/one module is hotter than the other. It would therefore be advantageous from the point of view of the performance, efficiency, and working life of batteries, if an automated, improved, and efficient solution for active thermal management for batteries could be provided, which provides improved heat transfer capability and can detect hot spots and deliver more cooling to the hot spots.

Patent document U.S. Pat. No. 9,786,969B2 discloses a vehicle traction battery assembly that includes an array of battery cells, a thermal plate in thermal communication with the array and defining a coolant path, and an electromagnet. The electromagnet is arranged within the coolant path as an electromagnet valve assembly to selectively output a magnetic field to influence magnetic particles to gather and remain stationary in a specific pattern so that one or more separate coolant sub-paths can be defined by the coolant flowing therethrough. The battery assembly also includes sensors such as a thermistor and temperature gauge located proximate to the battery and configured to output a signal indicative of the temperature of the battery cells. A controller, in response to the output signal from the sensors, is configured to direct the electromagnet to adjust the magnetic field based on the temperature of the battery cells, which selectively output the magnetic field to restrict the flow of coolant through the separate coolant paths in order cool the battery. As can be seen, the cited reference focuses on using electromagnets as a valve assembly to create sub-cooling paths in the main cooling path to cool all the battery cells along the sub-cooling paths, in case a rise in temperature of the battery cells is detected by the sensor, which may be inefficient as well as ineffective. However, the cited reference fails to detect hot spots in the battery and also fails to deliver cooling to only the hot spots regions of the battery. Thus, the cited reference does not provide a satisfactory solution to the above-stated problem. Moreover, the use of sensors such as a thermistor or temperature gauge and electromagnets makes the overall assembly complex and bulky.

There is, therefore, a need to overcome the above-mentioned drawbacks, shortcomings, and limitations associated with existing battery thermal management techniques, and provide a simple, compact, efficient, and active thermal management system for a battery pack, which provides improved heat transfer capability and automatic hot spot detection to deliver efficient and variable cooling rate.

A general object of the present disclosure is to overcome problems associated with battery thermal management in vehicles and the existing thermal management techniques.

An object of the present disclosure is to provide a solution for active thermal management and cooling of batteries, which can provide improved heat transfer capability and can detect hot spots, and deliver more cooling to the hot spots.

Another object of the present disclosure is to provide a simple, compact, efficient, and active thermal management system for the battery, which provides improved heat transfer capability and automatic hot spot detection to deliver an efficient and variable cooling rate.

Another object of the present disclosure is to improve the life and performance of batteries efficiently and cost-effectively.

Another object of the present disclosure is to provide a compact and efficient battery pack with fast charging having improved heat transfer capability, which is capable of automatic hot spot detection to deliver efficient and variable cooling rates.

Aspects of the present disclosure relate to the technical field of thermal management systems for batteries. In particular, the present disclosure pertains to a simple, compact, efficient, and active thermal management system for a battery, which provides improved heat transfer capability and automatic hot spot detection to deliver efficient and variable cooling rates. Further, the present disclosure also relates to a compact and efficient battery pack “battery” with fast charging and improved heat transfer capability, which is capable of automatic hot spot detection to deliver efficient and variable cooling rates.

In an aspect, a thermal management system for a battery module is disclosed. The system comprises a thermally conductive plate having a first side and a second side. The one or more cells associated with the battery module are in thermal contact with the first side of the plate, and a coolant comprising ferromagnetic materials is configured to flow in thermal contact with the plate on the second side of the plate. The one or more coils are configured at predefined positions in the battery module on the first side of the plate. The predefined positions may comprise interstitial spaces between the one or more cells of the battery module. In in an event of heating of the one or more cells, the one or more coils are configured to get electromagnetically induced upon actuation by a DC current. Further, the one or more electromagnetically-induced coils on the first side of the plate are adapted to attract the ferromagnetic materials of the coolant toward the second side of the plate, which facilitates transfer of heat from the heated one or more cells to the coolant.

The system may comprise one or more negative temperature coefficient (NTC) resistors connected in series with the one or more coils, such that there is at least one NTC resistor in series connection with each of the coils. Further, one or more NTC resistors may also be in thermal contact with the one or more cells, such that there is at least one NTC resistor in thermal contact with each of the cells.

The resistance of the one or more NTC resistors may be selected/varied to provide a variable cooling, which enables automatic higher cooling at hot spots, by an increase in the DC current supplied to the coils associated with the heated one or more cells on account of reduced resistance due to heating, which may facilitate the attraction of the ferromagnetic materials of the coolant towards the heated one or more cells on the second side of the plate to cool the heated one or more cells.

In an aspect, the system may comprise an electrical power source electrically connected to the one or more coils. The power source may be configured to supply the DC current of predefined attributes to the one or more coils. Further, the power source may be connected to a battery management system and an electronic control unit of the vehicle.

The power source may be configured to supply a pulsating DC current of predefined frequency to the one or more coils, which may allow the ferromagnetic materials heated at the plate to return to the flowing coolant, and further allow cool ferromagnetic materials from the coolant to be attracted towards the plate.

In another aspect, a battery pack is disclosed. The battery pack comprises one or more battery modules, each comprising one or more cells. The battery pack further comprises a thermally conductive plate having a first side, and a second side. The one or more cells associated with each of the battery modules are in thermal contact with the first side of the plate, and a coolant comprising ferromagnetic materials is configured to flow in thermal contact with the plate on the second side of the plate. Further, the battery pack comprises one or more coils configured at predefined positions in the battery pack on the first side of the plate. In an event of heating of the one or more cells, the one or more coils are configured to get electromagnetically induced upon actuation by a DC current. The electromagnetically-induced coils on the first side of the plate are adapted to attract the ferromagnetic materials of the coolant towards the second side of the plate, which facilitates transfer of heat from the heated one or more cells to the coolant.

The predefined positions may comprise any or a combination of interstitial spaces between the one or more cells, and interstitial spaces between the one or more modules.

The battery pack may comprise one or more negative temperature coefficient (NTC) resistors connected in series with the one or more coils of each of the battery modules, such that there is at least one NTC resistor in series connection with each of the coils. The one or more NTC resistors may be in thermal contact with the one or more cells of each of the battery modules, such that there is at least one NTC resistor in thermal contact with each of the cells. The resistance of the one or more NTC resistors may be selected to provide variable cooling, which enables automatic higher cooling at hot spots, by an increase in the DC current supplied to the coils associated with the heated one or more cells on account of reduced resistance due to heating.

The battery pack may comprise a power source electrically connected to the one or more coils. The power source may be configured to supply a pulsating DC current to the one or more coils, which may allow the heated ferromagnetic materials to return to the flowing coolant, and further allow cool ferromagnetic materials from the coolant to be attracted toward the plate.

Various objects, features, aspects and advantages of the inventive subject matter will become more apparent from the following detailed description of preferred embodiments, along with the accompanying drawing figures in which like numerals represent like components.

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

### BRIEF DESCRIPTION OF THE DRAWINGS

FIGS. 1A to 1B illustrates an exemplary representation of the proposed thermal management system implemented in a battery module comprising multiple battery cells, in accordance with an embodiment of the present disclosure.

FIGS. 2A and 2B illustrate an exemplary side view of the proposed system having coils on one side and coolant with ferromagnets flowing on another side of the thermally conducting plate of the battery module to elaborate upon the working of the invention.

FIG. 3 illustrates an exemplary electrical circuit diagram of the proposed system, in accordance with an embodiment of the present disclosure.

FIG. 4 illustrates an exemplary representation of the proposed thermal management system implemented in a battery pack comprising multiple battery modules of FIGS. 1A and 1B in accordance with an embodiment of the present disclosure.

### DETAILED DESCRIPTION OF THE DRAWINGS

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Embodiments explained herein relate to a simple, compact, efficient, and active thermal management system for a battery, which provides improved heat transfer capability and automatic hot spot detection to deliver efficient and variable cooling rates. Embodiments explained herein further relate to a compact and efficient battery pack with fast charging having improved heat transfer capability, which is capable of automatic hot spot detection to deliver efficient and variable cooling rates

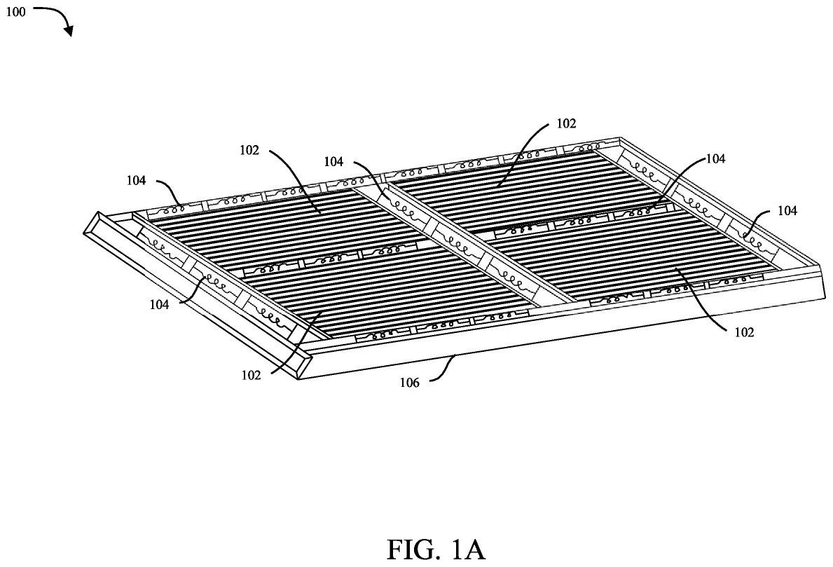

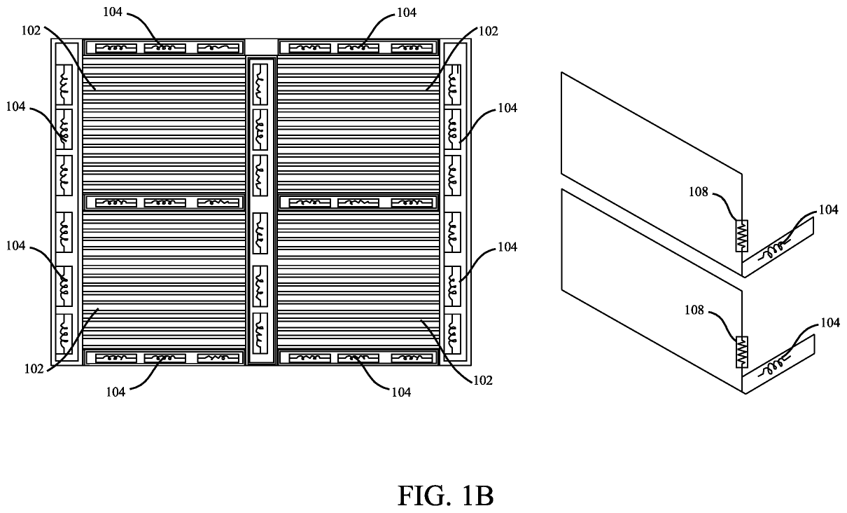

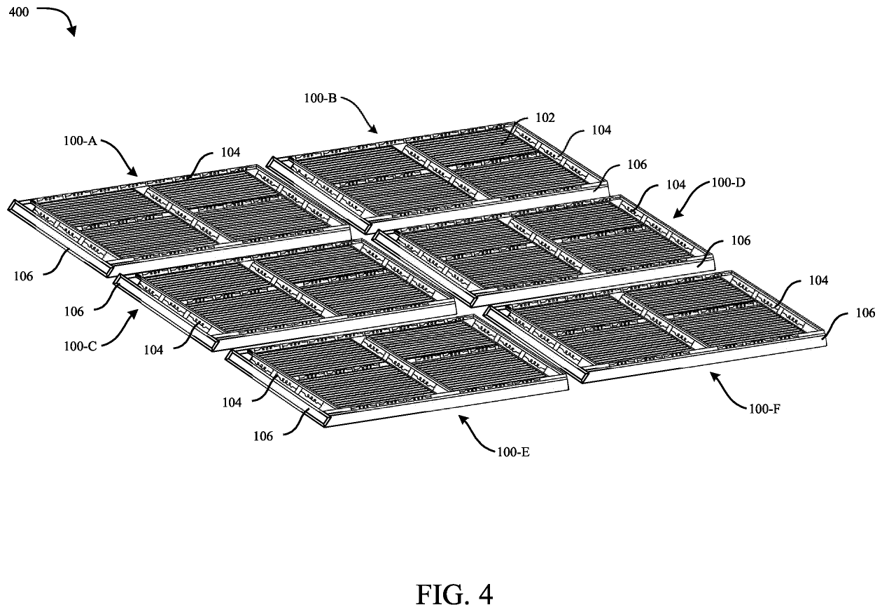

Referring to FIGS. 1A to 4, the proposed thermal management system (hereinafter, also referred to as system) for a battery module 100 and a battery pack 400 is disclosed. The battery pack 400 can include one or more battery modules 100-A to 100-F (collectively referred to as battery modules 100 and individually referred to as a battery module 100, herein) as shown in FIG. 4. Further, each of the battery modules 100 can include one or more battery cells 102 (collectively referred to as cells 102 and individually referred to as a cell 102, herein) as shown in FIGS. 1A and 1B.

The system can include one or more coils 104 (collectively referred to as coils 104 and individually referred to as a coil 104, herein) that may be miniaturized wound coils 104 having a predefined number of turns, such that actuation of the coils 104 by a DC power source 302 or DC current may turn the coils 104 into an electromagnet. Further, the system or battery module 100/battery pack 400 can include a thermally conductive plate 106 (also referred to as plate 106, herein) having a first side and a second side. The battery modules 100 or the cells 102 associated with the battery module 100 can be positioned in thermal contact with the first side of the plate 106. Further, the coils 104 can also be positioned on the first side (or cell 102 side) of the plate 106 in proximity to the cells 102.

Further, the system or battery module 100/battery pack 400 can include a coolant 110 comprising ferromagnetic materials 112 that can be configured to flow in thermal contact with the plate 106 on the second side of the plate 106. In an embodiment, a channel 114 may be provided on the second side of the plate 106 and the coolant 110 may be circulated through the channel 114 using a pump such that the flowing coolant 110 may remain in thermal contact with the second side of the plate 106. In an exemplary embodiment, a Fe/Glycol or other ferromagnetic materials 112 (nanoparticles or microscopic particles of the ferromagnetic material) may be suspended in the coolant 110.

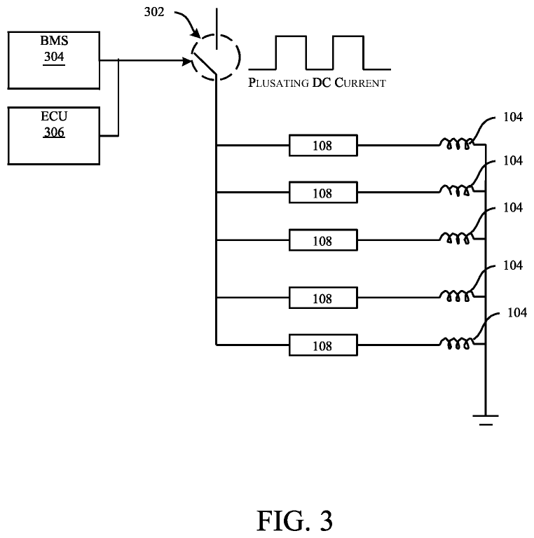

The system can include one or more negative temperature coefficient (NTC) resistors (collectively referred to as NTC resistors 108 or individually referred to as NTC resistor 108, herein) connected in series with the one or more coils 104 as shown in FIGS. 1B and 3, such that there is at least one NTC resistor 108 in series connection with each of the coils 104. The one or more NTC resistors 108 can be positioned in thermal contact with the cells 102, such that there is at least one NTC resistor 108 in thermal contact with each of the cells 102. In an embodiment, a network of the coils 104 and NTC resistor 108 can be placed and packaged in the interstitial spaces between cells 102, between the battery modules 100 in the battery pack 400, but not limited to the like. In an exemplary embodiment, the NTC resistors 108 can be positioned on the side of the cell 102 as shown in FIG. 1B.

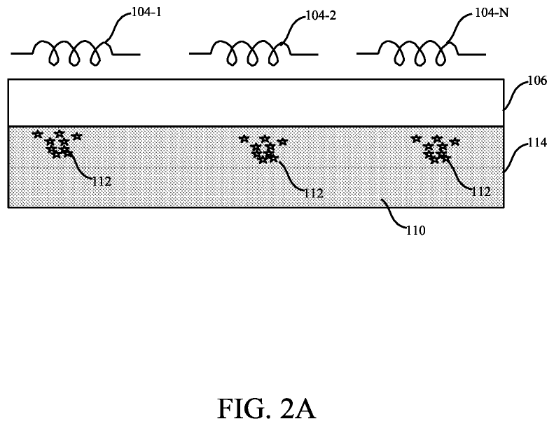

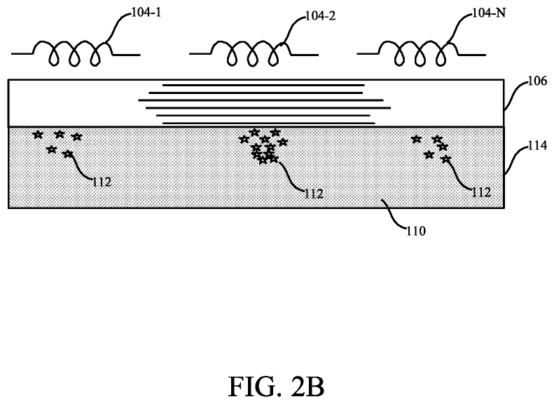

In an implementation, in an event of heating of the one or more cells 102, the coils 104 are configured to get electromagnetically induced upon actuation by the DC current or DC power source 302. Accordingly, the one or more electromagnetically-induced coils 104 on the first side of the plate 106 can act as an electromagnet to attract the ferromagnetic materials 112 of the coolant 110 towards the second side of the plate 106, which causes the ferromagnetic materials 112 to stick to the second side of the plate 106 as shown in FIGS. 2A and 2B. This can facilitate and enhance heat exchange between the heated cells 102 of the battery modules 100 and the plate 106 or coolant 110. The thermal conductivity between the heated cells 102 and the coolant 110 greatly increases now since there is a direct heat exchange between the plate 106 and the ferromagnetic material sticking to it in addition to the coolant 110 flow. Thus, the battery cell 102 can now transfer greater heat onto the plate 106.

The NTC resistors 108 are selected to provide variable cooling, which can enable automatic and enhanced cooling at hot spots (heated cells 102), by an increase in the DC current supplied to the coils 104 associated with the heated cells 102 on account of reduced resistance in the NTC resistor 108 due to heating, which can facilitate the attraction of the ferromagnetic materials 112 of the coolant 110 towards the heated one or more cells 102 on the second side of the plate 106 to cool the heated one or more cells 102. The NTC resistors 108 have a negative temperature coefficient, such that a rise in temperature of the NTC resistors 108 due to heating of any of the cells 102 (at hot spots in the battery module 100) results in the reduction of resistance of the NTC resistors 108 that are in thermal contact with the heated cells 102. This reduction in the resistance of the NTC resistors 108 at the hot spots increases the DC current supplied to the coils 104 at the hot spots but not to the remaining coils 104. This can facilitate the attraction of the ferromagnetic materials 112 being suspended in the coolant 110 majorly towards the heated cells 102 (hot spots) to cool the heated cells 102 at the hot spots.

The automatic detection of the hot spot and delivery of the variable cooling is done in this way the resistor values of the NTC resistors 108 vary depending on the heat of the different cells 102. For instance, the greater the heat generated by the cells 102, the smaller the resistance of the NTC resistor 108. Further, the smaller the resistance of the NTC resistor 108, the greater the current flowing into the coils 104 attached to that particular cell 102 and NTC resistor 108. In this way, the current and the magnetic field strength generated in the different coils 104 can automatically vary in such a way that the hottest cell 102 gets the maximum magnetic field strength and thereby maximum cooling and vice versa. For instance, as shown in FIG. 2B, the ferromagnetic materials 112 of the coolant 110 are attracted more to the plate 106 area at the hot spot regions created by heated cells 102 (near the coil 104-2) compared to other cells 102 (near coils 104-1 and 104-2) as the cell 102 associated with coil 104-2 is more heated.

Referring to FIG. 3, in an embodiment, the system or battery module 100/battery pack 400 can include an electrical power source 302 electrically connected to the one or more coils 104 through an NTC resistor 108 in series with each of the coils 104. The power source 302 can be further operatively coupled to a battery management system (BMS) 304 and/or an electronic control unit (ECU) 306 of a vehicle where the battery pack 400 is installed. The power source 302 can be configured to supply the DC current of predefined attributes to the one or more coils 104. In an embodiment, the power source 302 can be configured to supply a pulsating DC current of a predefined frequency (preferably low or very low frequency) to the one or more coils 104. This allows the ferromagnetic materials 112 being magnetically attached and heated at the second side of the plate 106 to return to the flowing coolant 110 and further allows cool ferromagnetic materials 112 from the coolant 110 to be attracted towards the plate 106 for further heat exchange. The sizing and number of turns of the coils 104 can be selected to generate a magnetic field value required to pull the weight of nano/microparticles of the ferromagnetic material suspended in the coolant 110.

Thus, the present disclosure overcomes the drawbacks, shortcomings, and limitations associated with the heating of battery modules and existing battery thermal management systems, by providing a simple, compact, yet efficient, and active thermal management system for a battery, which provides improved heat transfer capability and automatic hot spot detection to deliver efficient and variable cooling rates. Further, the present disclosure also provides a compact and efficient battery pack with fast charging having improved heat transfer capability, which is capable of automatic hot spot detection to deliver efficient and variable cooling rates. This facilitates fast charging, improves battery life and health, improves charging performance, and eradicates thermal issues such as thermal runaway or overheating of the battery.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

The present invention overcomes problems associated with battery thermal management in vehicles and the existing thermal management techniques.

The present invention provides a solution for active thermal management and cooling of batteries, which can provide improved heat transfer capability and can detect hot spots, and deliver more cooling to the hot spots.

The present invention provides a simple, compact, efficient, and active thermal management system for the battery, which provides improved heat transfer capability and automatic hot spot detection to deliver an efficient and variable cooling rate.

The present invention improves the life and performance of batteries efficiently and cost-effectively.

The present invention provides a compact and efficient battery pack with fast charging having improved heat transfer capability, which is capable of automatic hot spot detection to deliver efficient and variable cooling rates.

1-10. (canceled)

11. A thermal management system of a battery module (100), comprising:
a thermally conductive plate (106) having a first side and a second side, wherein one or more cells (102) associated with the battery module (100) are in thermal contact with the first side of the thermally conductive plate (106) and wherein a coolant (110) comprising ferromagnetic materials (112) is configured to flow in thermal contact with the thermally conductive plate (106) on the second side of the thermally conductive plate (106); and
one or more coils (104) configured at predefined positions in the battery module (100) on the first side of the thermally conductive plate (106), wherein, in an event of heating of the one or more cells (102), the one or more coils (104) are configured to get electromagnetically induced upon actuation by a DC current;
wherein one or more electromagnetically-induced coils (104) on the first side of the thermally conductive plate (106) are adapted to attract the ferromagnetic materials (112) of the coolant (110) toward the second side of the thermally conductive plate (106).

12. The thermal management system as claimed in claim 11, further comprising one or more negative temperature coefficient (NTC) resistors (108), wherein there is at least one NTC resistor (108) of the one or more negative temperature coefficient (NTC) resistors (108) in series connection with each of the one or more coils (104) and wherein there is at least one NTC resistor (108) of the one or more negative temperature coefficient (NTC) resistors (108) in thermal contact with each of the one or more cells (102).

13. The thermal management system as claimed in claim 12, wherein a resistance of the one or more NTC resistors (108) is selected to provide a variable cooling, which enables automatic higher cooling at hot spots, by an increase in the DC current supplied to the one or more coils (104) associated with heated one or more cells (102) on account of reduced resistance due to heating, which facilitates attraction of the ferromagnetic materials (112) of the coolant (110) towards the heated one or more cells (102) on the second side of the plate (106) to cool the heated one or more cells (102).

14. The thermal management system as claimed in claim 12, further comprising an electrical power source (302) electrically connected to the one or more coils (104), wherein the electrical power source (302) is configured to supply the DC current of predefined attributes to the one or more coils (104).

15. The thermal management system as claimed in claim 14, wherein the electrical power source (302) is configured to supply a pulsating DC current of predefined frequency to the one or more coils (104) which allows ferromagnetic materials (112) heated at the thermally conductive plate (106) to return to the coolant (110) and allows cool ferromagnetic materials (112) from the coolant (110) to be attracted towards the thermally conductive plate (106).

16. The thermal management system as claimed in claim 11, wherein the predefined positions comprise interstitial spaces between the one or more cells (102).

17. A battery pack (400), comprising:
one or more battery modules (100) each comprising one or more cells (102);
a thermally conductive plate (106) having a first side and a second side, wherein one or more cells (102) respectively associated with each of the battery modules (100) are in thermal contact with the first side of the thermally conductive plate (106) and wherein a coolant (110) comprising ferromagnetic materials (112) is configured to flow in thermal contact with the thermally conductive plate (106) on the second side of the plate (106); and
one or more coils (104) configured at predefined positions in the battery pack (400) on the first side of the thermally conductive plate (106), wherein, in an event of heating of the one or more cells (102), the one or more coils (104) are configured to get electromagnetically induced upon actuation by a DC current;
wherein electromagnetically-induced coils (104) on the first side of the thermally conductive plate (106) are adapted to attract the ferromagnetic materials (112) of the coolant (110) toward the second side of the thermally conductive plate (106).

18. The battery pack (400) as claimed in claim 17, further comprising one or more negative temperature coefficient (NTC) resistors (108), wherein there is at least one NTC resistor (108) of the one or more negative temperature coefficient (NTC) resistors (108) in series connection with each of the one or more coils (104), wherein there is at least one NTC resistor (108) of the one or more negative temperature coefficient (NTC) resistors (108) in thermal contact with each of the one or more cells (102), and wherein a resistance of the one or more NTC resistors (108) is selected to provide a variable cooling, which enables automatic higher cooling at hot spots, by an increase in the DC current supplied to the one or more coils (104) associated with heated one or more cells (102) on account of reduced resistance due to heating.

19. The battery pack (400) as claimed in claim 18, further comprising a power source (302) electrically connected to the one or more coils (104), wherein the power source is configured to supply a pulsating DC current to the one or more coils (104) which allows heated ferromagnetic materials (112) to return to the coolant (110) and allows cool ferromagnetic materials (112) from the coolant (110) to be attracted towards the thermally conductive plate (106).

20. The battery pack (400) as claimed in claim 18, wherein the predefined positions comprise interstitial spaces between the one or more cells (102) and/or interstitial spaces between the one or more battery modules (100).
